(19) United States
(12) Patent Application Publication
(10) Pub. No.: US 2008/0090512 A1
(43) Pub. Date: Apr. 17, 2008

(54) Method of managing the restriction of incoming services

(75) Inventors: John Ross Little, Chelmsford (GB); Tanguy L. Bourgault, Crawley (GB)

Correspondence Address: OLIFF & BERRIDGE, PLC, P.O. BOX 320850, ALEXANDRIA, VA, 22320-4850, US

(73) Assignee: AEROMOBILE, LTD., CRAWLEY (GB)

(21) Appl. No.: 11/898,163

(22) Filed: Sep. 10, 2007

Related U.S. Application Data
(60) Provisional application No. 60/843,505, filed on Sep. 11, 2006.
(60) Provisional application No. 60/844,112, filed on Sep. 13, 2006.
(60) Provisional application No. 60/874,486, filed on Dec. 13, 2006.

(51) Int. Cl. H04K 3/00; H04M 1/66; H04M 17/00; H04Q 7/20

(52) U.S. Cl. 455/1; 455/406; 455/411; 455/431

(57) ABSTRACT

Systems and methods of managing restrictions on communications devices, including receiving a request from a mobile device to access a communication network. The request may contain key or other access control information. Systems and methods may include transmitting a data content that is tailored to (1) defeat automated processing or (2) human perception, to a mobile device. A response from the mobile device may be received and assessed to determine whether a human user likely reviewed the data content and initiated the response. Access to the communication network may be granted based on an assessment that the request or response contains appropriate key or other access control information or that a human user likely reviewed the data content and initiated the response.

### CLAIM FOR PRIORITY

This application claims priority to U.S. Provisional Applications Nos. 60/843,505, filed Sep. 11, 2006; 60/844,112, filed Sep. 13, 2006; and 60/874,486, filed Dec. 13, 2006. The disclosure of each of the above-mentioned applications is hereby incorporated by reference herein in its entirety.

### BACKGROUND

This disclosure is directed to systems and methods for enabling and disabling service to users of mobile devices including but not limited to mobile communication devices.

Wireless communication systems are known that allow users to communicate via a handset or other mobile apparatus to a base station. The base stations may be connected directly or indirectly to other networks and/or other mobile or fixed communication devices. In common wireless communication systems, an access network system serves a plurality of mobile devices. The access network enables the mobile devices to access large communication networks that link the access network to other communication networks. Typically a wireless access network is provided with at least one station, or base station, and mobile devices may communicate wirelessly with the base station or, alternatively, with a plurality of base stations during a single communication. The use of mobile transceivers has become increasingly popular. Based on several inherent and extrinsic characteristics of such communication systems, however, certain challenges limit the usefulness of such systems.

An example of such a challenge resides in providing service to users traveling on mobile platforms, particularly trains and/or aircraft that move in and out of coverage areas for specific access networks or base stations. In such instances, certain conventional systems are limited in their ability to maintain communication with a given support system, access network or base station. This challenge has been addressed, in part, by the development of “picocell” systems that provide alternative mobile base stations for use with mobile transceivers. An example of such a system is the ARINC and Telenor Incorporated AeroMobile® communication platform. AeroMobile® provides alternative service to mobile phone users onboard equipped aircraft.

A separate challenge arises in implementing such systems within aircraft in the form of potential safety risks caused by electromagnetic radiation emitted by the mobile transceivers potentially interfering with aircraft avionics systems. Thus, it has been proposed to control mobile transceivers to limit the transmission power of the mobile transceivers when used in such picocell systems. U.S. Pat. No. 5,995,833 to Zicker proposes a system that controls radio telephones residing in a vehicle such that the radio telephones are transmitting at minimal power levels.

Alternatively, systems have been proposed that eliminate the electromagnetic emissions of the mobile transceivers by exchanging an individual mobile transceiver's SIM card with a receptor in a phone that is fixedly connected to an aircraft's mobile communication network. U.S. Pat. No. 7,058,401 to Sinivaara et al. proposes a system in which RF interference is avoided by using fixed links between a transceiver and user terminals. According to Sinivaara, passengers put their own SIM cards, or other identifier, in a receptor in the fixed user terminal.

### SUMMARY

Various wireless systems, including picocell systems, use registration methods to establish and maintain service with individual mobile transceivers. These methods may include, for example, transmitting a unique code resident within the individual mobile transceiver and exchanging check sums based on information provided by a control network. Communication and linkage details are known to those of ordinary skill in the art and will not be repeated here.

Other methods of limiting communication for transceivers onboard aircraft include evaluating whether or not an individual mobile transceiver's characteristics are compatible with a set of predetermined parameters such as user equipment power level. For example, U.S. Patent Application Publication No. 2004/0192188 to Dieudonne discloses testing and registering individual communication devices for use onboard aircraft.

Despite attempts made to address other issues regarding limitations of mobile communication devices, new challenges continue to emerge, particularly in today's security-conscious environment. Security issues relating to the use of cellular phones (or other terminals) onboard an aircraft, or in other environments, have become more prominent and continue to present challenges to providing and managing service to mobile devices. For example, the use of cellular phones as triggering devices has become a significant concern in the airline industry and other security-conscious environments. Also, automated hacking of communication systems has become increasingly possible due to advances in technology.

Regarding the use of cellular phones as triggering devices, it may be advantageous to ensure that an actual person is using an individual cellular phone, before allowing incoming services to be directed to that phone. For example, a known method of using a cellular telephone as a triggering device involves connecting the ringer or alert circuit to a detonator whereby if the cellular phone receives an incoming call, the detonator is triggered. Thus, in order to address such a problem, it may be advantageous to restrict incoming services to mobile communication devices, such as cellular telephones, until it can be positively established that the mobile device is in the possession of and/or actually being used by a person.

Disclosed systems and methods provide means for managing a restriction on incoming services to ensure that mobile devices, such as a transceiver, are actually in the possession of and being used by a person prior to forwarding communication services to the mobile device.

Although described in the context, for example, of cellular telephones in communication with an aircraft-installed picocell, the disclosure is not limited to such applications. Rather, disclosed systems and methods may find applicability in any context in which security, or other concerns, suggest restricting service, and particularly incoming services, to mobile devices such as transceivers where any advantage arising from employing the below described methods for providing indicia that a given mobile device is being used by a person may be realized.

In various exemplary embodiments, systems and methods according to this disclosure may provide enhanced means for managing incoming services to mobile transceivers.

In various exemplary embodiments, systems and methods according to this disclosure may be directed to receiving a request from a communication device to access a communication network. In response to the request, data content may be transmitted to the communication device. The data content may be tailored to human perception and/or to defeat automated processing. A response from the communication device may then be assessed to determine whether a human user reviewed the data content and initiated the response. Access to the communication network may be granted or denied based on the assessment. For example, access to the communication network may be granted if the assessment indicates a human user reviewed the data content and initiated the response.

In various exemplary embodiments, the systems and methods according to this disclosure may limit the number of attempts an individual mobile device may make to access a communication network and may identify mobile devices that fail to provide a proper response in a set number of attempts. Based on this identification, subsequent attempts by the individual mobile device to access the network may be rejected. Additionally, identifying information of the mobile device may be saved and/or transmitted.

In various exemplary embodiments, identified requesting receivers may be transferred to alternative processing means, such as human management personnel to provide further assistance.

In various exemplary embodiments, a data content comprising distorted audible instructions that are discernible by human users yet difficult and/or impractical for automated systems to decipher may be sent to a specified mobile device to initiate a challenge and reply method for verifying or updating access of the specified mobile device to a communication network. Such distorted audible instructions may comprise a numeric sequence to be entered by the user of the communication device or other like actions. In such instances, assessing the response to determine whether a human user reviewed the data content and initiated the response may comprise matching a response numeric sequence of the response with the numeric sequence of the distorted audible instructions, or other like actions. As an alternative, or in addition, to the above, audible instructions may include requests for simple calculations or other information that would not be readily understood and processed by automated systems.

In various exemplary embodiments, systems and methods according to this disclosure may include wherein data content comprising distorted images for display on a display device in or associated with a mobile device. In various exemplary embodiments, systems and methods according to this disclosure may include tailoring the data content based on at least one of a user preference, a detected mobile device setting, or a detected mobile device capability.

In various exemplary embodiments, systems and methods according to this disclosure may include capabilities to implement one or more of functions of obstructing communication between a mobile device and a communication network, canceling an obstruction between a mobile device and a communication network, or granting access of a mobile device to an alternative communication network, based on an assessment indicating whether or not a human user reviewed data content transmitted from a communication network, or otherwise, and received via the mobile device, and initiated a response to the received data content. Such assessment may be made in the communication network or otherwise.

In various exemplary embodiments, an exemplary system for managing restrictions on service to mobile communication devices may include: a receiver that receives a request from a mobile communication device or otherwise to access a communication network; a transmitter that transmits a data content to the mobile communication device, the data content tailored to human perception and/or to defeat automated processing; and control circuitry configured to assess a response from the mobile communication device to determine whether a human user reviewed the data content and initiated what may be assessed as a proper response, the control circuitry then granting or denying access to the communication network based on result of the assessment indicating whether or not a human user likely reviewed the data content and initiated the response.

In various exemplary embodiments, exemplary systems and methods may include capability within the control circuitry or otherwise to receive and/or store one or more user preferences regarding for example a form of data content and/or tailor data content based on at least one of a received or stored user preference, or for example a detected mobile communication device setting, or a detected mobile communication device capability.

In various exemplary embodiments, exemplary systems and methods may also include a jammer, jamming means or step to obstruct communication between a mobile communication device and a communication network when a control circuitry for example is configured to at least one of cancel an obstruction to communication between a mobile communication device and a communication network, or to grant access for a mobile communication device to an alternate communication network, or otherwise adjust a flow of communication to a mobile communication device, based on an assessment of whether a human user reviewed a data content and an initiated a response to the data content or an assessment of a received response.

In various exemplary embodiments, systems and methods according to this disclosure may include generating a key or other access authorization means to facilitate allowing limited and/or authorized access a picocell communication system. A request from a mobile communication device to access the picocell communication system may be received. The request may be independently assessed without separate transmission from the receiver to determine whether the request contains a correct key, or other access authorization, and access to the picocell communication system may be granted if the assessment indicates the request contains a correct key or other access authorization.

In various exemplary embodiments, disclosed systems and methods may include a key or other access authorization means being valid for a defined period of time, and/or linked to an individual user or mobile communication device, a specified base station, or an individual picocell system.

In various exemplary embodiments, systems and methods according to this disclosure may be used in conjunction with, or incorporated in, an AeroMobile® communication system.

It should be appreciated that although this discussion is primarily focused on picocell communication systems such as those that may be installed in, and/or employed onboard aircraft, the systems and methods according to this disclosure should not be construed as limited to such implementations. Rather, disclosed systems and methods may find application in any scenario in which enhanced methods for managing communication to and/or from mobile devices, such as transceivers, and a communication network may be advantageously employed to allow or limit access to the communication network based on some determination involving identifying a human user of the mobile device.

These and other objects, advantages and features of the systems and methods according to this disclosure are described in, or apparent from, the following description of embodiments.

### BRIEF DESCRIPTION OF THE DRAWINGS

Various exemplary embodiments of disclosed systems and methods will be described, in detail, with reference to the following figures wherein:

FIG. 1 illustrates a communication environment in which an exemplary embodiment of a system for managing communication services between mobile devices and communication networks according to this disclosure may be employed;

FIG. 2 schematically illustrates a block diagram of an exemplary system for managing communication between mobile devices and a communication network according to this disclosure;

FIG. 3 is a flowchart illustrating a first exemplary method for managing communication between mobile devices and a communication network according to this disclosure; and

FIG. 4 is a flowchart illustrating a second exemplary method for managing communication between mobile device and a communication network according to this disclosure.

### DETAILED DESCRIPTION OF EMBODIMENTS

The following description of various exemplary embodiments of systems and methods for managing communication between mobile devices and communication networks may refer to, and/or illustrate, a picocell communication system onboard an aircraft, the picocell system supporting, for example, individual cellular telephones for individuals embarked on the aircraft, for the sake of clarity and ease of depiction and description. However, it should be appreciated that the disclosed principles, as outlined and/or discussed below, can be equally applied to any known, or later-developed, system in which it would be advantageous to manage communication between mobile devices and communication networks based on assessments regarding whether mobile devices are actually in the possession of, and/or being used by, human users.

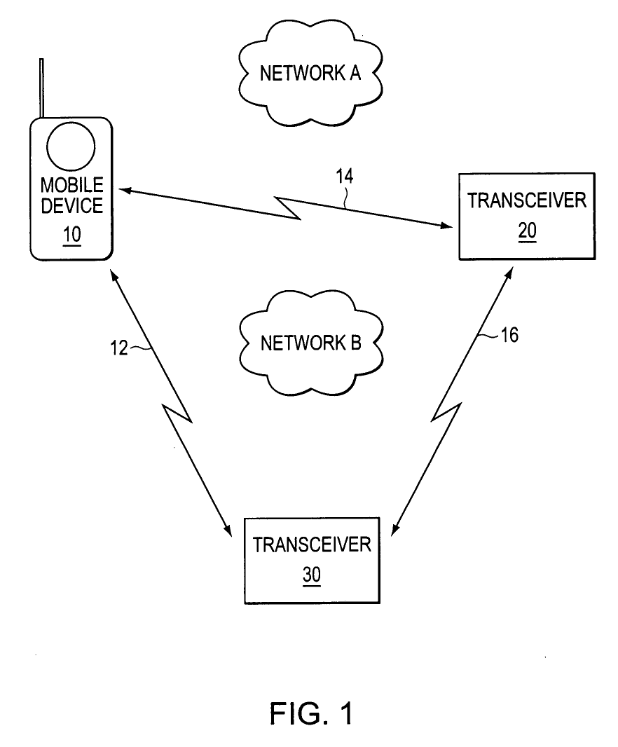

FIG. 1 illustrates a communication environment in which an exemplary embodiment of a system for managing communication services between mobile devices and communication networks according to this disclosure may be employed. A mobile device 10 may be configured to communicate via a primary network B using at least one transceiver 30. Examples of mobile devices 10 may include but not be limited to cellular telephones, handheld radio transceivers, handheld computer products, laptop computers, pagers, and like items. A communication path between mobile device 10 and network B is represented by signal 12. A second transceiver 20 may also be configured to communicate with mobile device 10 and also with transceiver 30.

The mobile device 10 may request access to network A via a communication link 14 to transceiver 20. Transceiver 20 may exchange data content with mobile device 10 in response to a request for access to network A. Mobile device 10 may be used to transmit a response to the data content to transceiver 20. The response may be assessed to indicate whether a human user reviewed the data and initiated the response. Based on the assessment, access to network A may be granted or denied.

In embodiments where network A is a secondary communication network, such as a picocell network onboard an aircraft, transceiver 20 may act as a link between mobile device 10 and a second network B, such as that depicted as being accessed by transceiver 30.

In exemplary embodiments, mobile device 10 may transmit a request for access to network A, including a key or other access authorization means, to transceiver 20. The request may be assessed to determine whether the transmitted key or other access authorization means received from the mobile device 10 corresponds to a previously generated key that may not have been transmitted to mobile device 10. For example, a key may be generated and stored by transceiver 20. This key or other access authorization means is not transmitted to mobile device 10 but is distributed via other means to users in a controlled manner, such as for example audibly over an aircraft intercom system. Different from embodiments in which automated requests for access require an exchange of information between a mobile device and a communication network, this embodiment may make a determination based on information transmitted from the mobile device, without a transmission from transceiver 20 or network A. This may be advantageous in reducing the activated systems within the requesting transceiver, thereby reducing the potential for using the transceiver as a detonator.

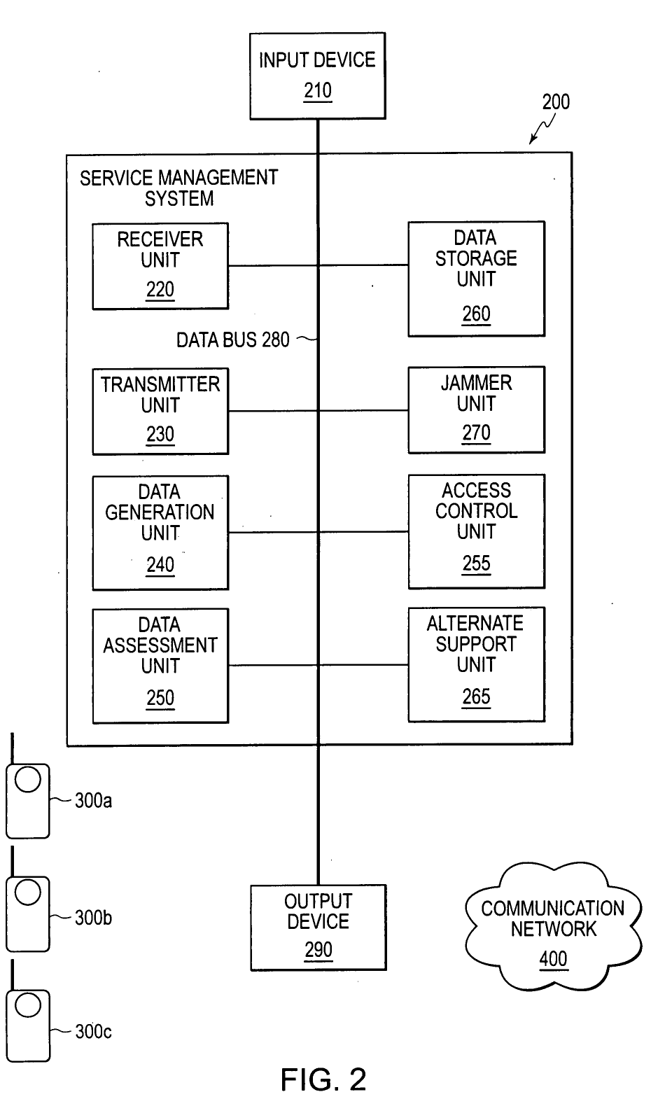

FIG. 2 schematically illustrates a block diagram of an exemplary system 200 for managing communication between mobile devices and a communication network. Exemplary service management system 200 may include an input device 210, a receiver unit 220, a transmitter unit 230, a data generation unit 240, a data assessment unit 250, an access control unit 255, a data storage unit 260, an alternate support unit 265, a jammer unit 270 and an output device 290, all connected by a data/communication bus 280. Service management system 200 may be configured to interact with multiple mobile devices 300 and at least one communication network 400 via for example wireless electronic communication.

The service management system 200 may receive requests for access to a communication network 400 from a mobile device 300 via the input device 210 and/or receiver unit 220. Such requests may include key or other access control information, as described above.

In cases where the request contains key or other access control information, such information may be compared to a key or other access control information previously generated by data generation unit 240 and/or stored in storage unit 260, by data assessment unit 250. Such comparison may include, for example, direct comparison of key data or combination/checksum comparisons to identify the validity of the key. In exemplary embodiments, the key or other access control information may not have been transmitted to the local device 300. This may be accomplished, for example, by having a user input key information to the mobile device 300.

In circumstances where the request for access does not contain key or other access control information, the data generation unit 240 may generate and/or access stored tailored data content to transmit to the requesting transceiver via transmitter unit 230 and/or output unit 290.

The tailored data content may include distorted audible instructions that are discernable by human beings yet difficult and/or impractical for automated systems to decipher. Such distorted audible instructions may include an alphanumeric sequence to be entered by the user of the mobile device.

The tailored data content may also include audible instructions that are discernable by human beings but difficult and/or impractical for automated systems to process and respond to appropriately. Such distorted audible instructions may include an alphanumeric sequence to be entered by the user of the mobile device.

A response to the transmitted data content may be received via input device 210 or receiver unit 220 in similar manner to the request for access. Such response may be assessed by the data assessment unit 250 to determine whether the response contains indications that it is likely that a human user reviewed the data content and/or initiated the response. Such assessment may include determining whether an appropriate alphanumeric sequence has been received as included in the response, whether an audible and/or alphanumeric response is a logical and/or correct response to instructions provided in the data content or other like assessments.

If the assessment by the data assessment unit indicates that a human user is likely not to have reviewed the data content and/or initiated the response, or if the assessment does not indicate that a human user likely reviewed the data content and/or initiated the response, the access attempt may be logged and saved in data storage unit 260 up to a point where a predetermined number of attempts have been made from a specific mobile device. After a predetermined number of failed attempts, an individual mobile device may be identified and future access attempts rejected based on this identification. Alternatively, a number of unsuccessful attempts may cause a request to be forwarded to alternate support unit 265 that may be employed to, for example, connect a requesting mobile device to a remote support center for further processing.

In instances where an assessment indicates that a human user likely reviewed the data content and/or initiated the response, access control unit 255 may provide the requesting transceiver access to the communication network 400.

Exemplary embodiments may also include wherein access to the system can be suspended or terminated automatically or by a manager controlling the system or a user using the mobile device. Examples of suspending, terminating or otherwise modifying access to a system automatically may include altitude-based restrictions initiated in response to data provided by avionics or other outside sources (not shown) via input device 210. Additionally, suspension, termination or other adjustments may be made by a manager or other operator via input device 210. For example, if a security threat is detected, service to selected, or all, users of a system may be suspended.

Any data storage contemplated for various exemplary embodiments of the disclosed system may be implemented using any appropriate combination of alterable memory or fixed memory. The alterable memory, whether volatile or non-volatile, may be implemented using any one or more of static or dynamic RAM, a miniaturized internal disk drive with associated disk-type medium, a hard drive, a flash memory or any other like memory medium and/or device. Similarly, fixed memory can be implemented using any one or more of ROM, PROM, EPROM, EEPROM, or compatible internal disk drive, or any other like memory storage medium and/or device.

It should be appreciated that, given the required inputs, the generating, assessing, and granting access outlined above to be undertaken in exemplary manner by the service management system 200, may be implemented through software algorithms, hardware or firmware circuits, or any combination of software, hardware, and/or firmware control and/or processing elements.

It should be further appreciated that, although depicted as a system and/or set of subsystems internal to the exemplary service management system 200, the above-described functionalities for at least transmission, reception, key generating, assessing, jamming and/or granting access may occur with the applicable systems not being internal to and/or in any manner integral to the service management system 200. Rather, each of the described functionalities of the receiver unit 220, transmitter unit 230, data generation unit 240, data assessment unit 250, data storage unit 260, jammer unit 270, access control unit 255 and alternate support unit 265 may be implemented as one or more external devices to the exemplary service management system 200. It should be appreciated that each of the one or more devices and/or units, and the exemplary capabilities described as being associated with each of the one or more devices and/or units, may be implemented through any manner of data exchange and communication with the exemplary service management system 200.

It should be appreciated that although depicted as separate individual elements, any of the depicted individual units and/or devices may be combinable with other individual units and/or devices as combined units and/or devices within the exemplary service management system 200. Further, while depicted as a hard-wired data/control bus 280, any data communication path by which data and control inputs may be exchanged between individual units and/or devices, and/or combination units and/or devices, within the exemplary service management system 200 is envisioned. Such data communications paths may include individual wired and/or wireless and/or optical communications connections, or any combination of such connections between communicating elements. Additionally, one or more of the depicted individual elements and/or combination units or devices, as discussed above, may be located external to, and otherwise in data communication with, the exemplary service management system 200.

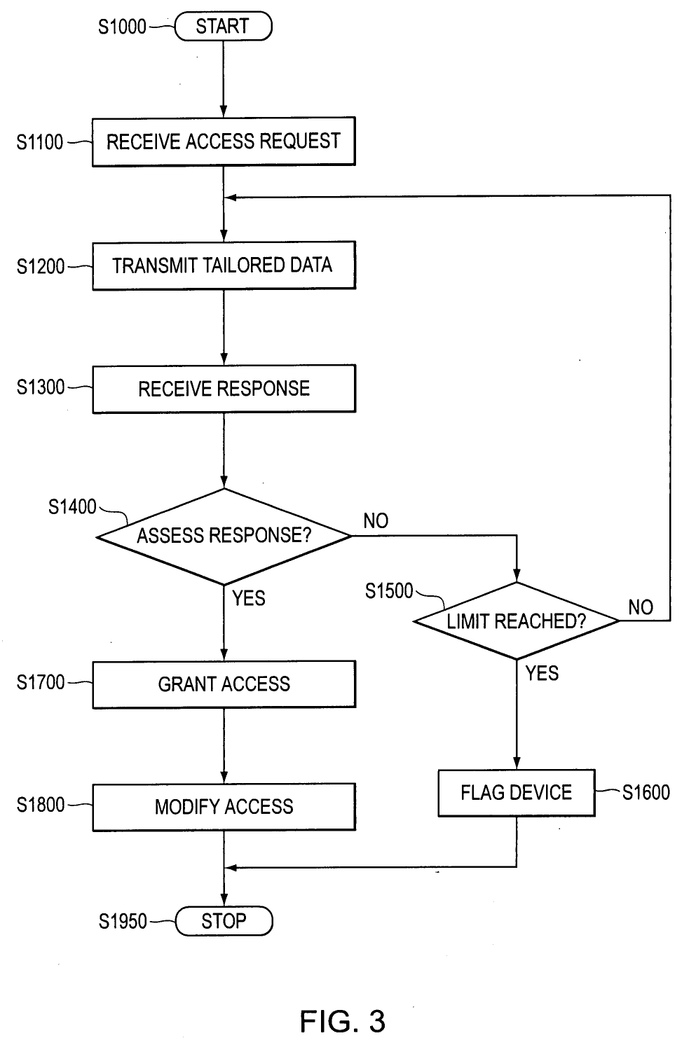

FIG. 3 is a flowchart illustrating a first exemplary method for managing communication between mobile devices and a communication network. Operation of the method commences at step S1000 and continues to step S1100.

In step S1100, a request for access to a communication network may be received from a mobile device. The request may contain a data content identifying the mobile device. Operation of the method continues to step S1200.

In step S1200, a tailored data content may be transmitted to the requesting mobile device. The tailored data content may include for example at least one of distorted images for display by the mobile device, distorted audible instructions, audible instructions including simple calculations or other information not readily understood and processed by automated systems. Operation of the method continues to step S1300.

In step S1300, a response to the tailored data content may be received from the requesting mobile device. Such response may be associated with the requesting mobile device through identifying data content contained in the response. Operation of the method continues to step S1400.

In step S1400, the response is analyzed to assess whether it is sufficiently likely, in accordance with predetermined criteria or methodology, that a human user reviewed the tailored data content and/or initiated the response.

If, in step S1400, the assessment does not indicate that a human user likely reviewed the tailored data content and/or initiated the response, operation of the method proceeds to step S1500.

If, in step S1400, the assessment indicates that a human user reviewed the tailored data content and/or initiated the response, operation of the method proceeds to step S1700.

In step S1500, a determination is made whether a predetermined number of attempts to access the network have been made by the requesting mobile device.

If, in step S1500, the determination indicates that a predetermined number of attempts have not been made, operation of the method returns to step S1200.

If, in step S1500, the determination indicates that a predetermined number of attempts have been made, operation of the method continues to step S1600.

In step S1600, the request from mobile device may be alternatively processed, for example, to identify and restrict further access requests from the mobile device, to save identifying information of the mobile device for future reference, and/or by transferring the request to an alternative support system. Operation of the method continues to step S1950 where operation of the method ceases.

In step S1700, the requesting mobile device is granted a level of access to the communication system. The level of access may be based on various factors including, for example, manager and/or provider preferences, stored data associated with an identified user or mobile device, flight conditions, security levels, or other, commercial, safety or security issues. Access may include allowing incoming and/or outgoing transmissions to or from the requesting mobile device. Operation of the method continues to step S1800.

In step S1800, access to the communication network may be modified such as, for example, restricting, suspending, restoring or canceling the access. The modification may be initiated, for example, automatically, or manually by a user of the requesting mobile device, or a manager of the communication system. Examples of automatic modifications may include altitude based suspensions and/or cancellation of service as may be necessary during final approach and/or landing procedures. Alternatively, or in addition to such automatic modifications, managers or other operators of the communication system may selectively or system-wide modify access to the communication system. Individual users of requesting mobile devices may also modify granted access in accordance with predetermined options. Operation of the method continues to step S1950 where operation of the method ceases.

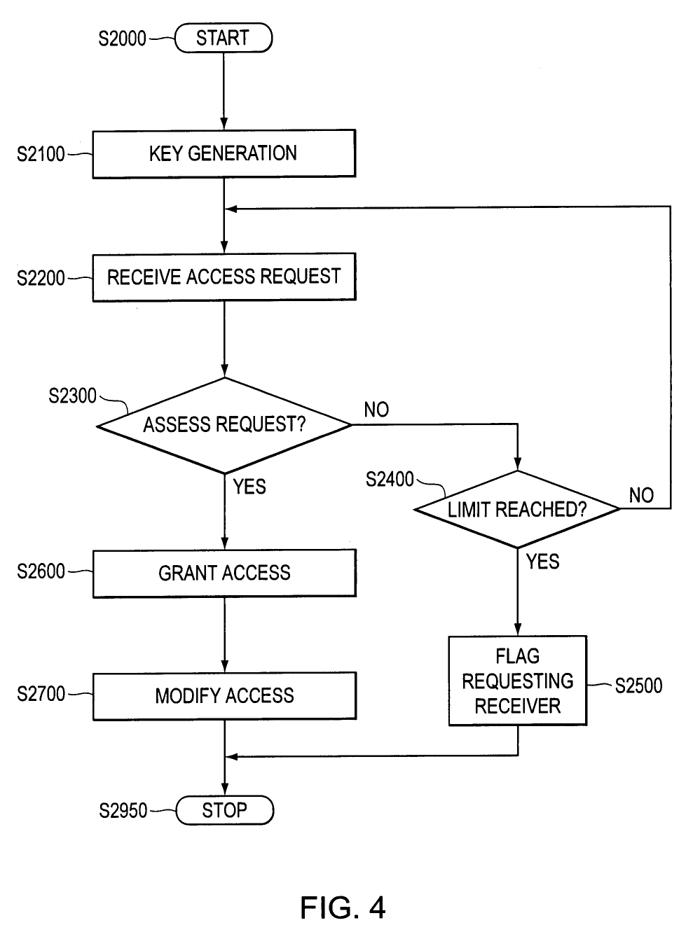

FIG. 4 is a flowchart illustrating a second exemplary method for managing communication between mobile device and a communication network.

It should be appreciated that although the method depicted in FIG. 4 may differ from the method depicted in FIG. 3, such methods may be conducted concurrently or independently by individual or similar disclosed systems. Further, features of each method may be incorporated in a single or multiple cooperating systems, units or devices.

Operation of the method commences at step S2000 and continues to step S2100.

In step S2100, a key or other access control information is generated. Operation of the method continues to step S2200.

In step S2200, request for access to a communication network may be received from a mobile device. The request may contain a data content identifying the mobile device and key or other access control information. Operation of the method continues to step S2300.

In step S2300, the request is analyzed to assess whether any key or other access control information contained in the request corresponds to the generated key information.

If, in step S2300, the assessment does not indicate the presence of corresponding key or other access control information, operation of the method proceeds to step S2400.

In step S2400, a determination is made whether a predetermined number of attempts to access the network have been made by the identified mobile device.

If, in step S2400, the determination indicates that a predetermined number of attempts have not been made, operation of the method returns to step S2200 and awaits any further requests for access from the transceiver.

If, in step S2400, the determination indicates that a set number of attempts have been made, operation of the method continues to step S2500.

In step S2500, the identified transceiver may be further identified, or “flagged,” for example, to restrict further access requests, save identifying information of the transceiver, and/or transfer the request to an alternative support system. Operation of the method continues to step S2950 where operation of the method ceases.

If, in step S2300, the assessment indicates the presence of corresponding key information, operation of the method proceeds to step S2600.

In step S2600, the mobile device is granted a level of access to the communication system. The level of access may be based on various factors including, for example, manager and/or provider preferences, stored data associated with an identified user or mobile device, flight conditions, security levels, or other, commercial, safety or security issues. Access may include allowing incoming and/or outgoing transmissions to or from the transceiver, or combinations thereof. Operation of the method continues to step S2700.

In step S2700, access to the communication network may be modified such as, for example, restricting, suspending, restoring or canceling the access. The modification may be initiated, for example, automatically, or manually by a user of the requesting mobile device, or a manager of the communication system. Examples of automatic modifications may include altitude based suspensions and/or cancellation of service as may be necessary during final approach and/or landing procedures. Alternatively, or in addition to such automatic modifications, managers or other operators of the communication system may selectively or system-wide modify access to the communication system. Individual users of requesting mobile devices may also modify granted access in accordance with predetermined options. Operation of the method continues to step S2950 where operation of the method ceases.

As indicated previously, it should be appreciated that the second exemplary method may be performed in conjunction with aspects of the first exemplary method and features of each method may be incorporated in a single or multiple cooperating systems, units or devices.

While exemplary embodiments have been described above, the exemplary embodiments, and variations thereof, should be viewed as illustrative, and not limiting. Various modifications, substitutes, or the like may be possible to implement the systems and methods according to this disclosure, and such variations are reasonably contemplated by reference to the above-discussed exemplary embodiments of the systems and methods according to the disclosure.

What is claimed is:

1. A method of managing restrictions on communications devices, comprising:
receiving a request from a mobile device to access a communication network;
transmitting a data content to the mobile device that is tailored to at least one of defeat automated processing and human perception;
receiving at least one response from the mobile device;
assessing the response; and
granting access to the communication network based on the assessment.

2. The method of claim 1, wherein assessing the response includes determining whether a human user likely reviewed the data content and initiated the response; and
granting access to the communication network is based on if the assessment indicates a human user likely reviewed the data content and initiated the response.

3. The method of claim 1, wherein the data content comprises distorted audible instructions.

4. The method of claim 3, wherein the distorted audible instructions comprise a numeric sequence to be entered by the user of the mobile device.

5. The method of claim 1, wherein the data content comprises audible questions.

6. The method of claim 4, wherein assessing the response to determine whether a human user reviewed the data content and initiated the response comprises matching a response numeric sequence of the response with the numeric sequence of the distorted audible instructions.

7. The method of claim 5, wherein assessing the response to determine whether a human user reviewed the data content and initiated the response comprises applying a logical analysis to a response content based on the audible question.

8. The method of claim 1, wherein the data content comprises distorted images for display by the mobile device.

9. The method of claim 1, further comprising tailoring the data content based on at least one of a user preference, a detected mobile device setting, or a detected mobile device capability.

10. The method of claim 1, further comprising at least one of modifying, suspending and canceling granted access based on at least one of detection of predetermined criteria and manual intervention by a system administrator.

11. The method of claim 1, wherein the communication network is provided by an picocell system onboard an aircraft.

12. The method of claim 1, wherein the communication network is provided by an AeroMobile® system onboard an aircraft.

13. A method of managing restrictions on communications devices, comprising:
obstructing communication between a mobile device and a communication network;
receiving a request from a mobile device to access a communication network;
transmitting a data content to the mobile device that is tailored to at least one of defeat automated processing and human perception;
receiving at least one response from the mobile device;
assessing the response; and
at least one of canceling the obstruction between that mobile device and the communication network, or granting access to mobile device to the alternate communication network, based on the assessment.

14. The method of claim 13, wherein assessing the response includes determining whether a human user likely reviewed the data content and initiated the response; and
the at least one of canceling the obstruction between that mobile device and the communication network, or granting access to mobile device to the alternate communication network, is based on if the assessment indicates a human user likely reviewed the data content and initiated the response.

15. The method of claim 14, wherein the data content comprises distorted audible instructions.

16. The method of claim 15, wherein the distorted audible instructions comprise a numeric sequence to be entered by the user of the mobile device.

17. The method of claim 15, wherein determining whether a human user likely reviewed the data content and initiated the response comprises matching a response numeric sequence of the response with the numeric sequence of the distorted audible instructions.

18. The method of claim 13, wherein the data content comprises distorted images for display by the mobile device.

19. The method of claim 13, further comprising:
tailoring the data content based on at least one of a user preference, a detected mobile device setting, or a detected mobile device capability.

20. A system for managing restrictions on communications devices, comprising:
a receiver configured to receive a request from a mobile device to access a communication network;
a transmitter that transmits a data content to the mobile device, the data content tailored to at least one of defeat automated processing and human perception; and
control circuitry configured to assess a response from the mobile device and grant access to the communication network based on the assessment.

21. The system of claim 20, wherein assessing the response includes determining whether a human user likely reviewed the data content and initiated the response; and
granting access to the communication network is based on if the assessment indicates a human user likely reviewed the data content and initiated the response.

22. The system of claim 20, wherein the control circuitry is further configured to tailor the data content based on at least one of a user preference, a detected mobile device setting, or a detected mobile device capability.

23. The system of claim 21, wherein the data content comprises distorted audible instructions.

24. The system of claim 23, wherein the distorted audible instructions comprise a numeric sequence to be entered by the user of the mobile device.

25. The system of claim 24, wherein assessing the response to determine whether a human user reviewed the data content and initiated the response comprises matching a response numeric sequence of the response with the numeric sequence of the distorted audible instructions.

26. A system for managing restrictions on communications devices, comprising:
a jammer that obstructs communication between a mobile device and a communication network;
a receiver that receives a request from the mobile device to access the communication network or an alternate network;
a transmitter that transmits a data content to the mobile device that is tailored to at least one of defeat automated processing and human perception;
control circuitry configured to assess a response from the mobile device and at least one of cancel the obstruction between that mobile device and the communication network, or grant access to the mobile device to the alternate communication network based on the assessment.

27. The system of claim 26, wherein assessing the response includes determining whether a human user likely reviewed the data content and initiated the response; and
the at least one of canceling the obstruction between that mobile device and the communication network, or granting access to mobile device to the alternate communication network, is based on if the assessment indicates a human user likely reviewed the data content and initiated the response.

28. The system of claim 27, wherein the data content comprises distorted audible instructions.

29. The system of claim 26, wherein the control circuitry is further configured to tailor the data content based on at least one of a user preference, a detected mobile device setting, or a detected mobile device capability.

30. A method of managing communication with mobile devices, comprising:
generating key data to access a picocell communication system;
receiving a request from a mobile device to access the picocell communication system;
assessing the request, without responding to the request, to determine whether the request contains correct key data; and
granting access to the picocell communication system if the assessment indicates the request contains correct key data.

31. The method of claim 30 wherein the key data is valid for a defined period of time.

32. A system for managing communication with mobile devices, comprising:
a key generator that generates a key data to allow access to a plurality of mobile devices to a picocell communication system;
a receiver configured to receive at least one request from at least one of the plurality of mobile devices to access the picocell communication system;
an assessment unit that assesses the request, without responding to the request, to determine whether the request contains correct key data; and
a control unit that grants access to the picocell communication system if the assessment indicates the request contains correct key data.
